(19) United States
(12) Patent Application Publication
(10) Pub. No.: US 2018/0300377 A1
(43) Pub. Date: Oct. 18, 2018

(54) HANDLING TEMPORAL DATA IN APPEND-ONLY DATABASES

(71) Applicant: Reza Paidar, Vaughan (CA)

(72) Inventor: Reza Paidar, Vaughan (CA)

(21) Appl. No.: 15/917,597

(22) Filed: Mar. 10, 2018

Related U.S. Application Data
(60) Provisional application No. 62/485,465, filed on Apr. 14, 2017.

(51) Int. Cl. G06F 17/30; G06F 7/08

(52) U.S. Cl. CPC G06F 17/30551; G06F 17/30498; G06F 17/30371; G06F 17/30377; G06F 7/08; G06F 17/30321

(57) ABSTRACT

The present invention provides system and method for implementing a temporal database. The method includes receiving one or more transactions that perform one or more operations to a table or collection of data records. Further, the method includes storing the data records within chunks and distributed over plurality of computer and storage media, wherein the data records are sorted by one or more parameters. Further, the method includes extracting temporal metadata from data records based on configuration. Further, the method includes storing the temporal metadata. Further, the method includes receiving temporal criteria entered by the user using a special command. Further, the method includes filtering data records of each table partition, or data collection involved in the query based on the temporal criteria and the temporal metadata before further processing, filtering and joining with other tables or data collections.

### CROSS-REFERENCE TO RELATED APPLICATION

The present application is related to U.S. provisional patent application No. 62/485,465, filed on Apr. 14, 2017. The entire disclosure of the above patent application is hereby incorporated by reference.

### FIELD OF THE INVENTION

The present application generally relates to temporal databases, and particularly to an efficient and simple mechanism for storing and retrieving temporal data.

### BACKGROUND

A database is a structure for storing and relating data within e.g. a computer system. Different database architectures exist depending on the intended usage. The primary use for general purpose databases is to manage and facilitate data entry and retrieval in relation to the relevant application. In database architecture, database management systems and temporal data are well known concepts. The most common type of database management systems is Relational Database Management Systems (RDBMS) where data is organized in tables. Each table consists of zero or more records that have the same structure (columns), wherein a record is a collection of columns, possibly of different data types, typically in fixed number and sequence. Data in each table could have references to data in other tables.

SQL (Structure Query Language) is the most common way of accessing data from the tables though different operation such as INSERT/UPDATE and SELECT operations in RDBMS. A user submits queries that may use one or more tables. The user can also INSERT or UPDATE data in the table using SQL. An example of RDBMS and SQL is a single table that stores currency exchange rates, CCY_RATE, at start of each business date. A user can query the currency exchange rate for a currency pair (e.g.: CAD/USD) as of any day or a number of days.

As data evolves over time, the data records in a database are updated to reflect the current state of data. In this case, the history of changes is lost, and we cannot query the data record as of a point in time in the past since the data record is updated whenever a new version of the record becomes available. In order to solve this problem, temporal data is used. A temporal data record includes one or more time information that determines the period of time when the data record is valid. Every modification of a temporal data record creates a new record and ends the validity the current record and sets the current record as the valid version. Temporal data includes timestamps and other information to indicate the start and end of the time the record is valid. Temporal queries are used to retrieve the data from the temporal database as of a point in time; past, present or future.

For example, two time stamps are added to the CCY_RATE table, startTime and endTime to indicate the time period in which the currency exchange rate was valid. At the beginning of the business day, the endTime of the current record (that was valid from the morning of the previous business day) is set to ‘now’ and a new record is inserted for the currency pair with startTime=‘now’ and endTime=NULL or to a date like 99991231 to indicate end of time. Now we can query the exchange rate for all currency pairs as of any point in time (@asOfTime) in the past using the following SQL query:

Select *
From CCY_RATE
Where @asOfTime >= startTime
AND @asOfTime < endTime,

The CCY_RATE table described above is an implementation of temporal data where each data record has a valid time period. We may need to add more time periods to the data record to satisfy other requirements.

Most widely used implementations of temporal data are SCD TYPE 2 (Slowly Changing Dimensions Type 2) and Bi-Temporal. The SCD TYPE 2 uses one time period (two timestamps), and the Bi-Temporal uses 2 time periods (four timestamps), one to indicate business validity and the other to indicate operational validity of the data record.

The data has to be time boxed in a query of temporal data. Using a RDBMS, each time period requires addition of two filter conditions for each table involved in the query. As an example, a query involving 3 SCD TYPE 2 tables will require 6 filter conditions to time box the data. A Bi-Temporal query will need 12 additional filter conditions. Further, updating temporal data in RDBMS is also more complex than those operations for non-temporal data. Since we keep the historical data, every update is implemented an UPDATE of the latest version of the record and INSERT of a new record that will be the current record.

Some RDBMS vendors have added new features to their products and made use of temporal data easier, but have not eliminated the complexity of design and use of temporal data. Append-only database management systems are gaining popularity to handle very large volumes of data. Traditional methods of implementation of temporal data in append-only database management systems are not possible or not practical as those methods require UPDATE of timestamps of the current version of data when a new version is INSERTed.

The above information is presented as background information only to help the reader to understand the present invention. Applicants have made no determination and make no assertion as to whether any of the above might be applicable as Prior Art with regard to the present application.

### BRIEF SUMMARY

It will be understood that this disclosure in not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

It is an objective of the present invention to remove the complexity of design and use of temporal data, and makes it possible to implement temporal data on append-only database management systems.

It is another objective of the present invention to create databases (relational, non-relational and nosql) that are able to store and retrieve temporal data in append-only and regular databases in much simpler way compared with the traditional temporal databases.

It is another objective of the present invention to retrieve relevant temporal information and store them as temporal metadata of the data record.

It is another objective of the present invention to filter data records of each partition, table or collection involved in the query based on the temporal criteria and the temporal metadata before further processing, filtering and joining with data from other tables or data collections.

In an embodiment, the present invention provides system and method for implementing a temporal database. The method includes receiving a one or more transactions that perform one or more operations to a table, and the table comprises a collection of data records. Further, the method includes storing the data records within chunks and distributed over plurality of computer and storage media, wherein the data records are sorted by one or more parameters. Further, the method includes extracting temporal metadata from data records based on configuration. Further, the method includes storing the temporal metadata. Further, the method includes receiving temporal criteria entered by the user using a special command or as a part of the query. Further, the method includes filtering data records of every partition, table or data collection involved in the query based on the temporal criteria and the temporal metadata further processing, filtering and joining with data from other tables or data collections.

In an embodiment, each record includes an entity identifier (entityId), a valid time, optional a transaction time, and a ‘deletedFlag’, where the entityId is common among all versions of the data record and each data record is uniquely identified by its entityId, valid time and optional transaction time. Only one version of data records with the same entityId is valid at each point in time.

In an embodiment, the one or more parameters comprise at least entityId, valid time and optional transaction time.

In an embodiment, the method further includes receiving a query submitted by the user to be executed as of point in time stated in the temporal criteria, reading the data records from the storage, in case the data records for the same identifier stored in chunks, sorting all data records with the same identifier based on their valid time and optional transaction time, finding a single data record that is valid as of the point in time stated by temporal criteria, if any, among all having the same identifier, and discarding the rest, passing the valid data records for further processing, filtering and joining with data from other tables or data collections by the query engine.

In an embodiment chunks of data are compacted time to time so that data records with the same identifier are placed into the same chunk to reduce the number of chunks based on system configuration of user command.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 illustrates an example of data record implementing SCD TYPE 2 stored in a table in a traditional RDBMS, according to a prior art;

FIG. 2a illustrates an example of data record stored in a table in a database management system, according to an exemplary embodiment of the present invention;

FIG. 2b illustrates an example of valid version of the same data record is determined in a database management system, according to an exemplary embodiment of the present invention;

FIG. 3a illustrates an example of versions of the same data record implementing SCD TYPE 2, are logically chained together in a traditional RDBMS having startTime of a later version be the same of endTime of its previous version;

FIG. 3b illustrates an example of versions of the same data record implementing SCD TYPE 2, are sorted based on their valid time in a database management system, according to an exemplary embodiment of the present invention;

FIG. 3c illustrates an example of temporal metadata that is extracted from SCD TYPE 2 data records, according to an exemplary embodiment of the present invention;

FIG. 4 illustrates an example of collecting and sorting of data records spread across several files in several computers in a database management system, according to an exemplary embodiment of the present invention;

FIG. 5 illustrates an example where a single version the data records with the same entity identifier is selected based on the user ‘point in time’ criteria before further processing, filtering and joining with data from other tables or data collections, according to an exemplary embodiment of the present invention;

FIG. 6 illustrates an example where a data record is logically deleted, according to an exemplary embodiment of the present invention;

FIG. 7a illustrates an example where only the valid version of data as of a point of time is returned based on a query submitted by the user, according to an exemplary embodiment of the present invention;

FIG. 7b illustrates an example where logically deleted data record is not available to query as of a point in time after its logical deletion, according to an exemplary embodiment of the present invention;

FIG. 8 illustrates an example where versions of the same data record implementing Bi-Temporal, are stored in a table in a RDBMS, according to a prior art;

FIG. 9a illustrates an example where versions of the same data record implementing Bi-Temporal, are stored in a table in a database management system, according to an exemplary embodiment of the present invention;

FIG. 9b illustrates an example where temporal metadata is extracted from Bi-Temporal data records according to an exemplary embodiment of the present invention;

FIG. 10 illustrates an example where all versions of data records are available to query when the temporal feature is disabled, according to an exemplary embodiment of the present invention; and

FIG. 11 illustrates a system for implementing a temporal database, according to an exemplary embodiment of the present invention.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Some embodiments of this invention, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present invention, the preferred, systems and methods are now described.

The present invention provides system and method for creating databases (relational, non-relational and nosql) that are able to store and retrieve temporal data in append-only and regular databases in much simpler way compared with the traditional databases. A data record (new and any update including logical DELETE) is inserted to the data base tables or data collections with temporal information. The configuration of the data base tables or data collection enables the system to retrieve relevant temporal information and store them as temporal metadata of the data record. This temporal metadata is internal to the system and not visible by the user. The meta data includes the entity identifier (the id of data record shared among all versions of the data record), the valid time (the point in time that the data should appear in query results), deletion flag (in case data was deleted at a point in time), transaction time (the time the record was added to the database or its source system) and any other time stamps that might be required by the specific implementation of temporal data.

By setting the temporal criteria (the temporal criteria is like setting the destination time in a time machine), the data retrieved by a user query will reflect the state of data as of the point in time stated by the temporal criteria. When a query is submitted, the temporal metadata is used to filter out all data records of each partition, table or collection involved in the query that do not match the temporal criteria before further processing, filtering and joining with data from other tables or data collections by the query engine. At most one version of the data record with a specific entity identifier that is matching the temporal criteria is available for further processing.

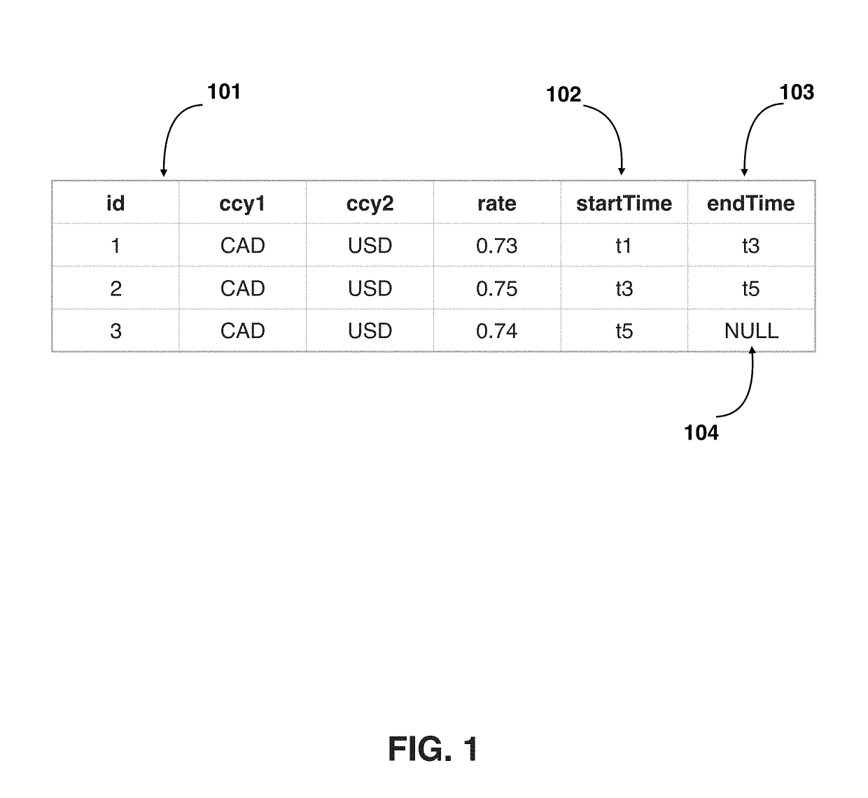

FIG. 1 illustrates an example of data records stored in a table (i.e., CCY_RATE table) in a traditional RDBMS, according to a prior art. In reference to FIG. 1, the data implements SCD TYPE 2 and is stored in the CCY_RATE table. The CCY_RATE table includes the exchange rate of currencies as of different points in time (here beginning of business day). The table data contains CCY1: currency 1, CCY2: currency 2 and rate which is the exchange rate between CCY1 and CCY2. The table includes an ‘id’ column 101 that uniquely identifies the data record, a ‘startTime’ column 102 that indicates the time the data record starts to be valid, and an ‘endTime’ column 103 that indicates that time beyond which the data record is not valid. If there is no endTime for the record, the endTime could be set to NULL 104 or a very large time such as 9999-12-31. Such a record is valid to the end of time. Consider a scenario, when the user input the below SQL query to fetch relevant data from the CCY_RATE table.

| | | |
|---|---|---|
| SELECT * | | |
| FROM CCY_RATE | | |
| WHERE @asOfTime >= startTime | {close oversize brace} | (1) |
| AND @asOfTime < endTime; | | |

As shown above the SQL code (1) with a filter condition returns data from the table valid as of a point in time @asOfTime. For @asOfTIme between t3 and t5, the row with id=id2 will be returned.

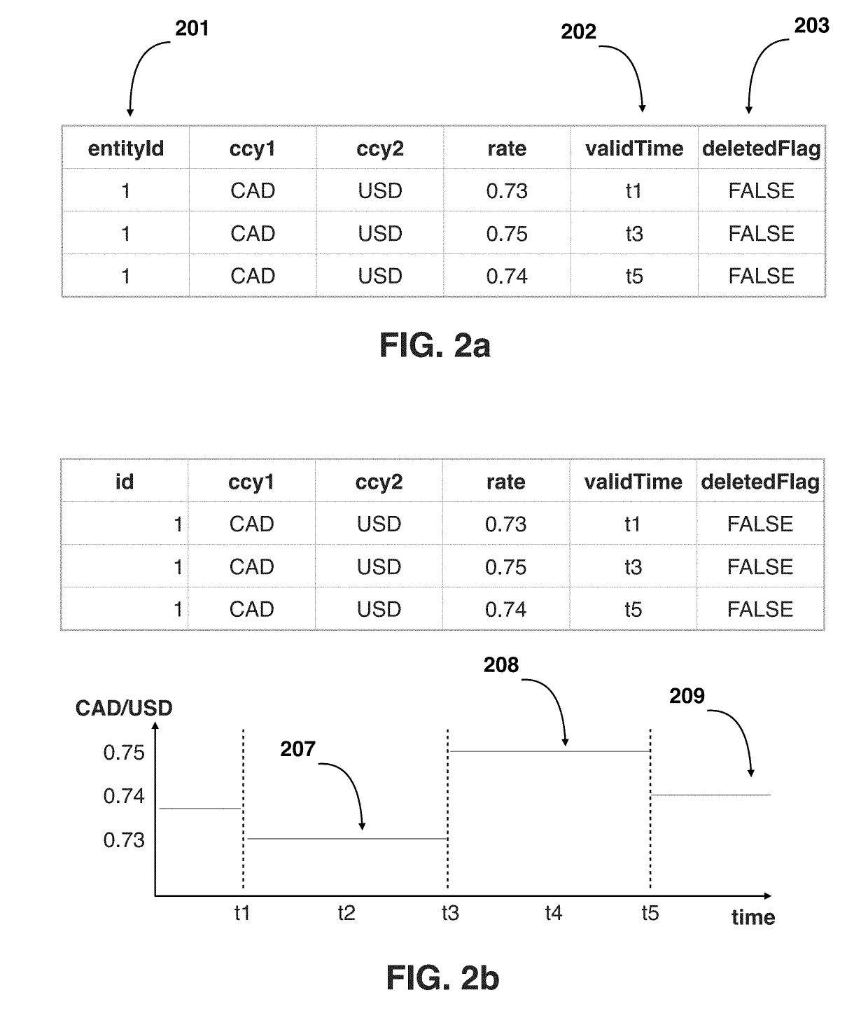

FIG. 2 illustrates an example of data record stored in a table (i.e., CCY_RATE table) according to an exemplary embodiment of the present invention. The table has an ‘entityId’ column 201 that is common to all versions of the same business data (here ccy1 and ccy2). Only one of the records with a specific entityId is valid at a point in time. The table has a validTime column 202 that indicates the time the data record starts to be valid, and a ‘deletedFlag’ 203 column that if set to TRUE indicates the the data record is deemed to be deleted after the ‘validTime’ of the record. Consider a scenario, when the user input the below SQL query to fetch relevant data from the CCY_RATE table.

| | | |
|---|---|---|
| SET temporalCriteria=validAsOf:tx; | | |
| SELECT * | {close oversize brace} | (2) |
| FROM CCY_RATE; | | |

As shown above the SQL code (2) with a command that sets the temporal criteria to be used. There is no filter condition similar to the SQL code (1). The temporal criteria instruct the system to return data that is valid as of time tx set in the criteria.

FIG. 2b illustrates valid version of the same data record is determined in a database management system, according to an exemplary embodiment of the present invention. The data in the table is shown on a graph. As shown, the rate of CAD/USD is 0.73 from t1 to t3, the rate of CAD/USD is 0.75 from t3 to t5, and the rate of CAD/USD is 0.75 from t5 and above.

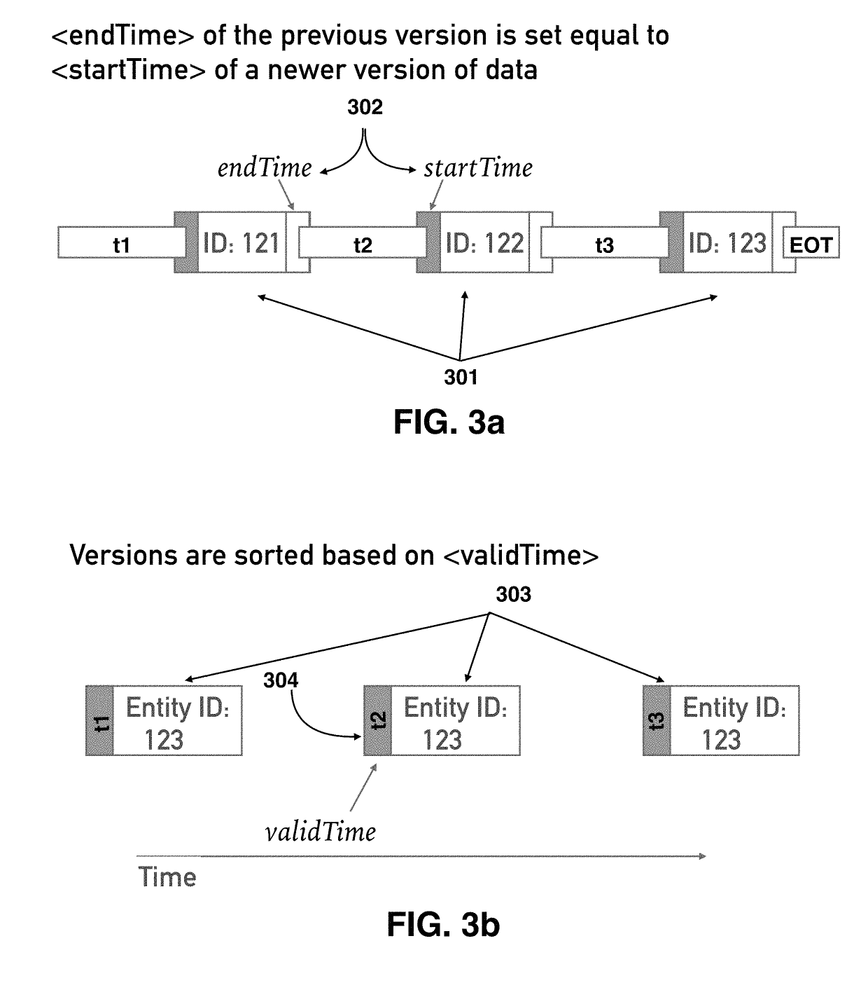

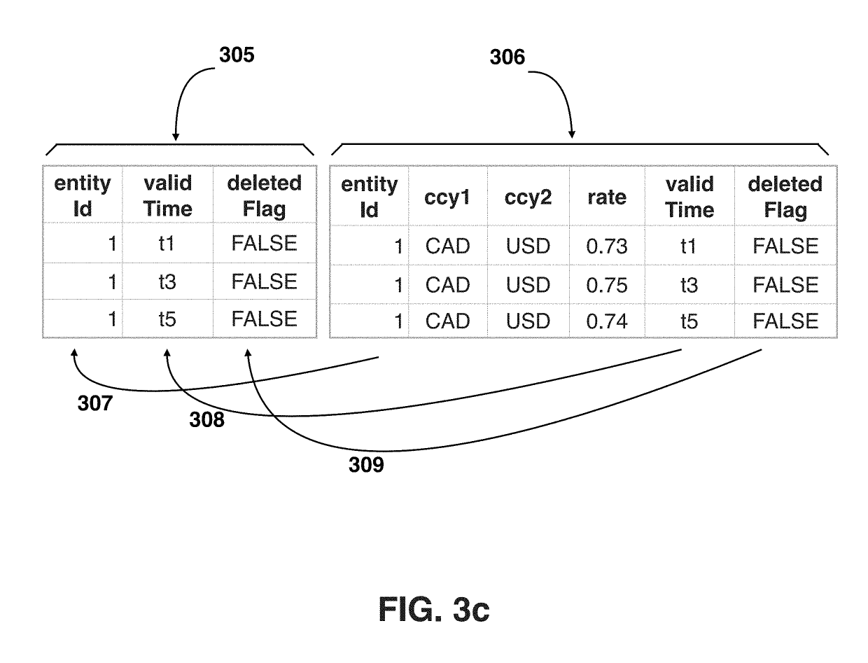

FIG. 3a illustrates an example of versions of the same data record implementing SCD TYPE 2, are chained logically together in a traditional RDBMS having startTime of a later version be the same of endTime of its previous version, according to an exemplary embodiment of the present invention. As shown, different versions of a data record 301 each having a unique id are linked together in an implementation of SCD TYPE 2 using a traditional RDBMS. The startTime of a new version is set to the endTime of its previous version 302.

FIG. 3b illustrates an example of versions of the same data record implementing SCD TYPE 2, are sorted based on their valid time in a database management system, according to an exemplary embodiment of the present invention. As shown, different versions of data records having the same entityId 303 are (logically) saved sorted by the validTime 304.

FIG. 3c illustrates an example of temporal metadata that is extracted from SCD TYPE 2 data records, according to an exemplary embodiment of the present invention. As shown, the temporal metadata 305 is stored along with the data records 306. The temporal metadata 307, 308, 309 are extracted from fields of data records based on configuration (i.e., the name of the fields id, validTime and deletedFlag in the data record could be different from the corresponding metadata fields).

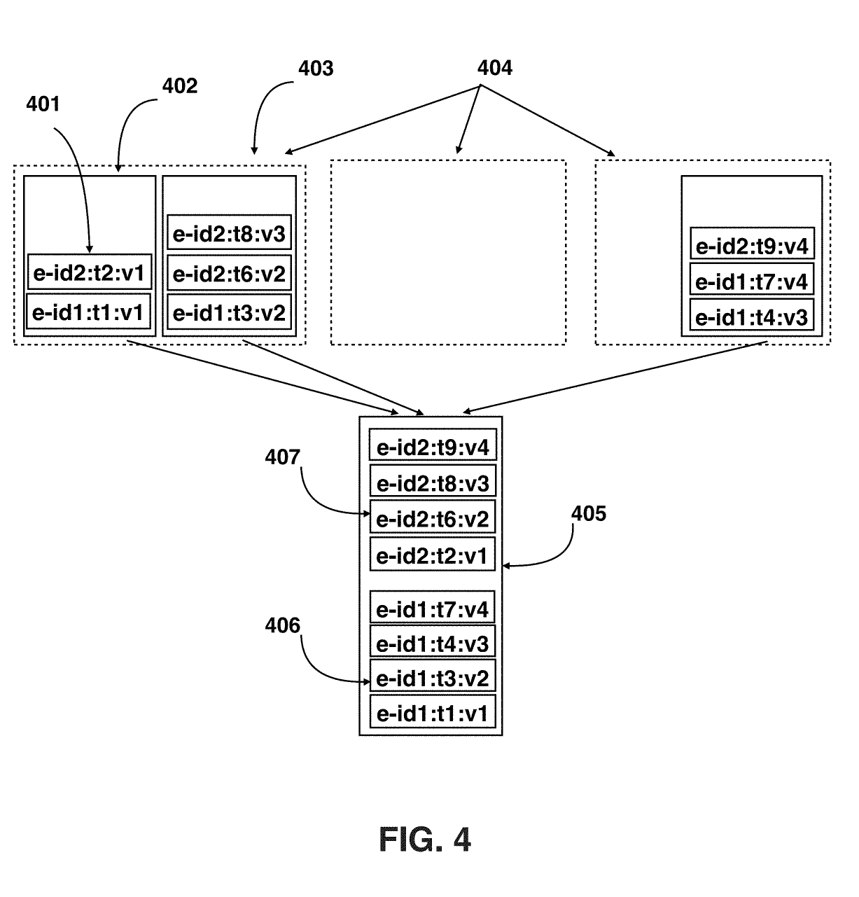

FIG. 4 illustrates an example of filtering of data records (with entityIds e-id1 and e-id2) based on the valid time and spread across several files in several computers in a database management system, according to an exemplary embodiment of the present invention. As shown, data records 401 are stored in chunks 402 where versions of data records with the same entityId are saved together and sorted by entityId and validTime descending. Several chunks are stored in a storage medium (e.g., disk, memory) on a computer system 403, and distributed across a plurality of computer systems 404. The data is read from these chunks 405 so that data records with the same entityId from all chunks are read sorted by validTime descending 406 and 407.

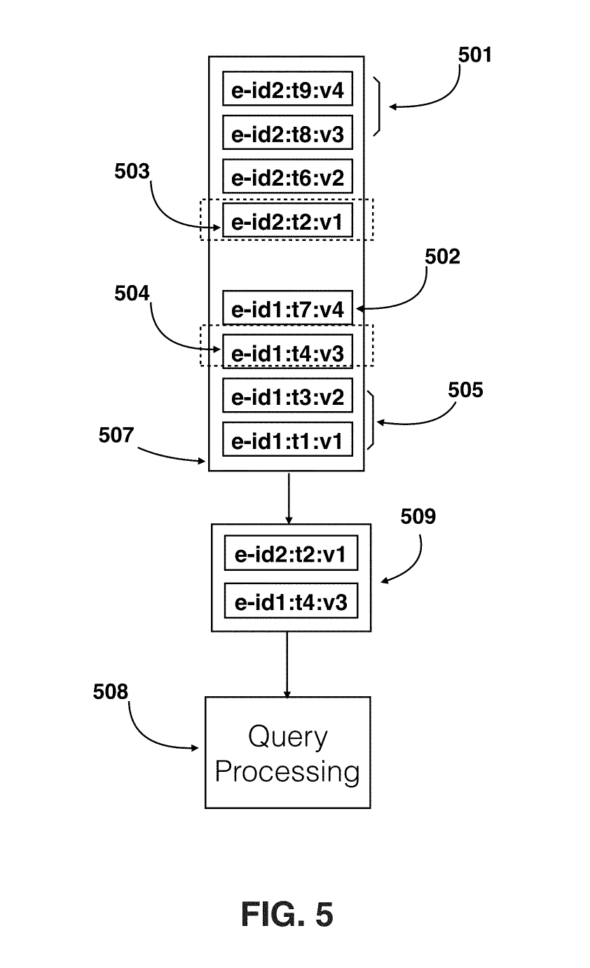

FIG. 5 illustrates an example where a single version the data records with the same entity identifier is selected based on the user ‘point in time’ criteria before further processing, filtering and joining with data from other tables or data collections by the query engine, according to an exemplary embodiment of the present invention. The data records with later validTimes are read first. The records with validTime greater than the time specified by temporal criteria (in this example t5) 501, 502 are discarded until the first record of each entityId with a validTime equal or before the time specified by temporal criteria is found. The first data record read with validTime equal or less than temporal criteria 503, 504 are deemed to match the temporal criteria and are further processed. The rest of data records with the same entityId 505 are also discarded. As shown in FIG. 5, the database that is built on the proposed method, where the query processing 508 receives only versions of data that match the temporal criteria 509 for further processing, filtering and joining with data from other tables or data collections.

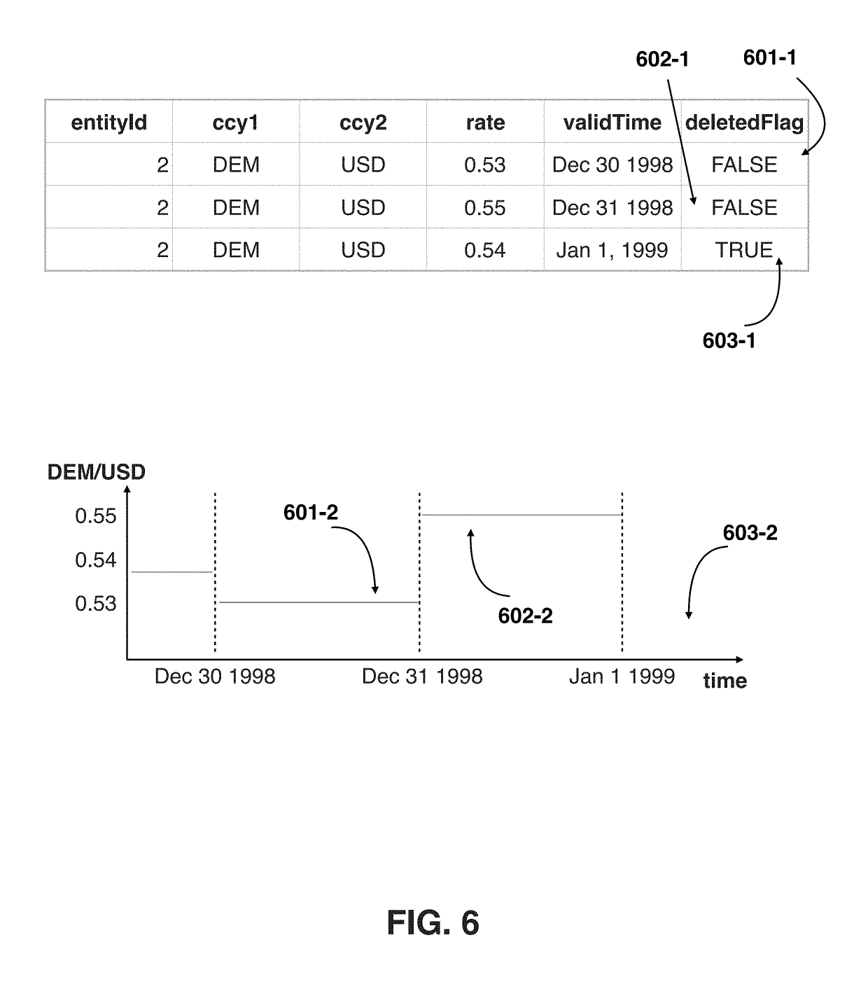

FIG. 6 illustrates an example where a data record is logically deleted, according to an exemplary embodiment of the present invention. As shown, the data records with deletedFlag of FALSE 601-1 and 602-1 are inserted for INSERT or UPDATE. To indicate a DELETE, a new row with the same entityID is inserted where deletedFlag is set to TRUE 603-1. The data record with that entityID is deemed to be deleted as of the validTime of the record with deletedFlag=TRUE. Any query with temporal criteria of equal to or later than validTime of that record will not be include any version of that data record. In this example the data record with entityId=2 (exchange rage of DEM/USD) will not exist on and after Jan. 1, 1999. Further, as shown in a graph, there is no exchange rate of DEM/USD (entityId=2) on and after Jan. 1, 1999 603-2.

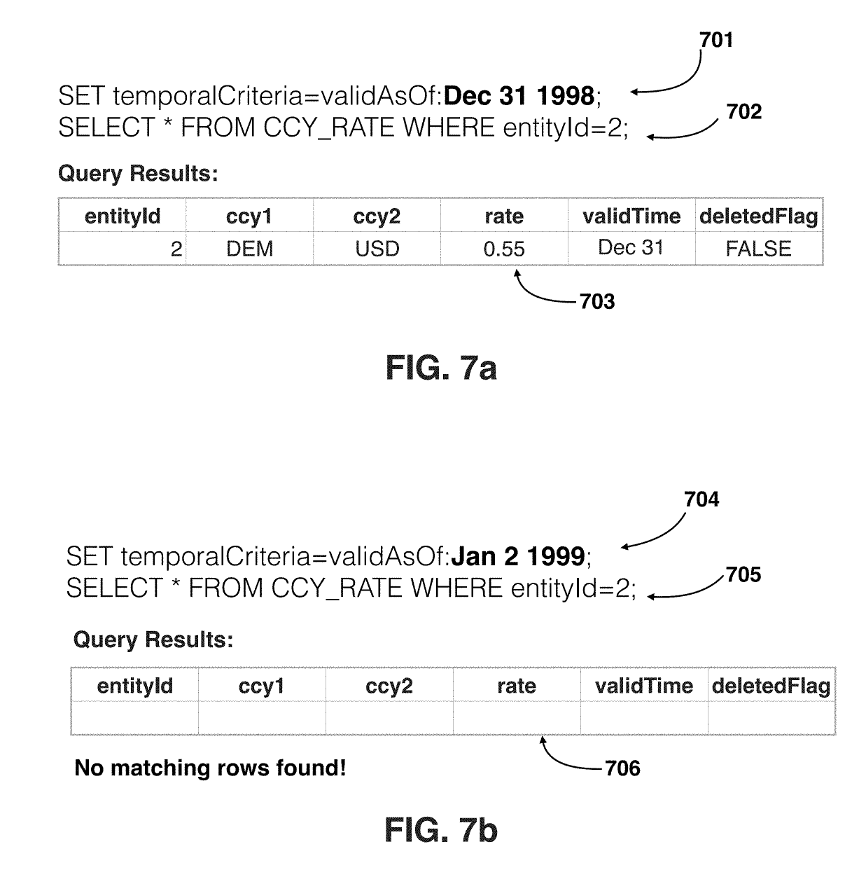

FIG. 7a illustrates an example where only the valid version of data as of a point of time is returned based on a query submitted by the user, according to an exemplary embodiment of the present invention. As shown, the query on the CCY_RATE table for entityId=1 as of Dec. 31, 1998 is submitted by the user. A special command (i.e., SET temporalCriteria=validAsOf=Dec. 31, 1998;) 701 is issued by the user to set the temporal criteria. The query to select from table (i.e., SELECT * FROM CCY_RATE WHERE entityId=2;) 702 is issued with no filter condition for temporal criteria. The record matching the temporal criteria is returned as a table 703.

FIG. 7b illustrates an example where logically deleted data record is not available to the query engine as a point in time after its logical deletion, according to an exemplary embodiment of the present invention. As shown, the query on the CCY_RATE table as of Jan. 22, 1999 which is later than the validTime of the DELETE of the entityId=2 Jan. 1, 1999 is submitted by the user. A special command (i.e., SET temporal Criteria=validAsOf=Jan. 2, 1999;) is issued by the user to set the temporal criteria. Since the entityId=2 (as shown in FIG. 6) was deleted before the time specified by temporal criteria, no record is returned 706.

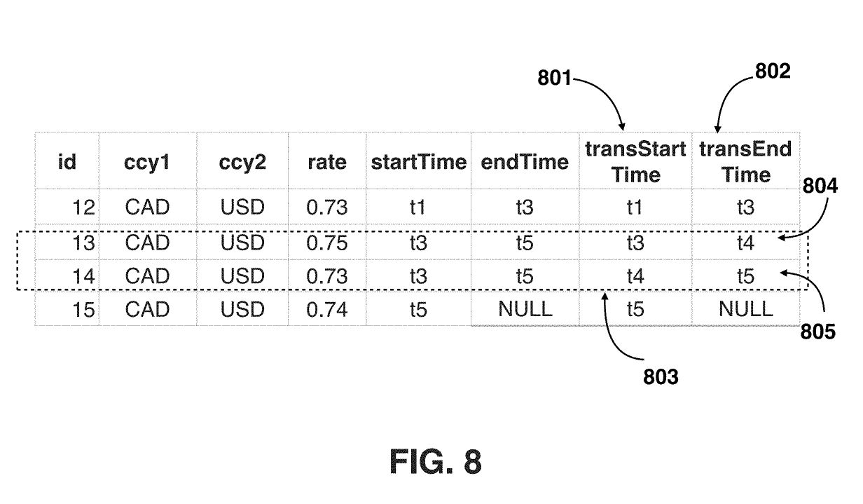

FIG. 8 illustrates an example where versions of the same data record implementing Bi-Temporal, are stored in a table in a RDBMS, according to a prior art. Data in a table in a traditional RDBMS that implements Bi-Temporal data is shown in FIG. 8. The table is similar to the table illustrated in FIG. 1a with addition of two more columns, transStartTime 801 and transEndTime 802. The two columns add a new temporal dimension, the transaction time to the table. Addition of these two columns enables the user to store the period of time when the record is valid from operational point of view. Records with id 13 and id 14 have the same startTime and endTime, but different transStartTime and transEndTime. This may happen for example if the operator of the system entered the rate in the record 13 by mistake at time t3, but corrected it at time t4. The Bi-Temporal data can answer the question what was the exchange rate of CAD/USD for business time between t3 and t5 as of any point in time between times t3 and t5.

Consider a SQL code (3) to select data records from the table as shown in FIG. 8a, as of a point in time in traditional RDBMS.

| | | |
|---|---|---|
| SELECT * | | |
| FROM CCY_RATE | | |
| WHERE @asOfTime >= startTime | | |
| AND @asOfTime < endTime | {close oversize brace} | (3) |
| AND @asOfTransTime >= transStartTime | | |
| AND @asOfTransTime < transEndTime | | |

The SQL code includes a filter condition that returns data from the table valid as of a point in time @asOfTime and transactionally valid as of a point in time @asOfTransTime. In an example, for @asOfTIme=t3 and @asOfTransTime=t3, the row with id=13 804 will be returned. For a @asOfTIme=t3 and @asOfTransTime=t4, the row with id=14 805 will be returned.

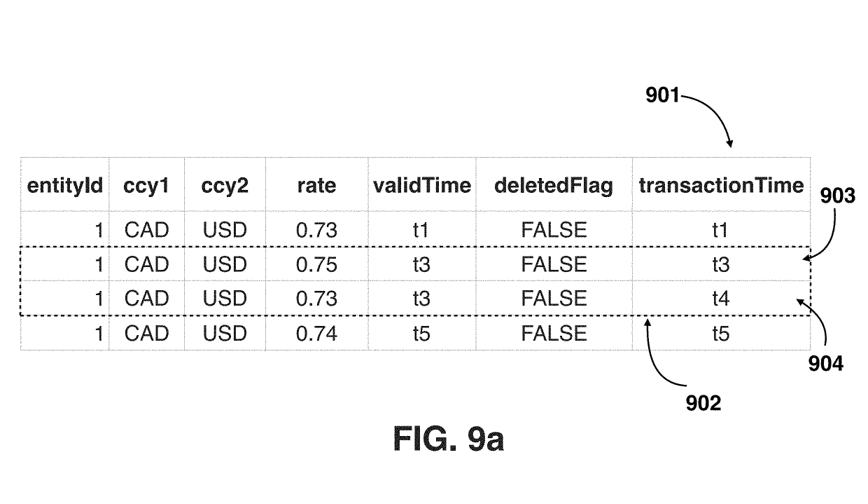

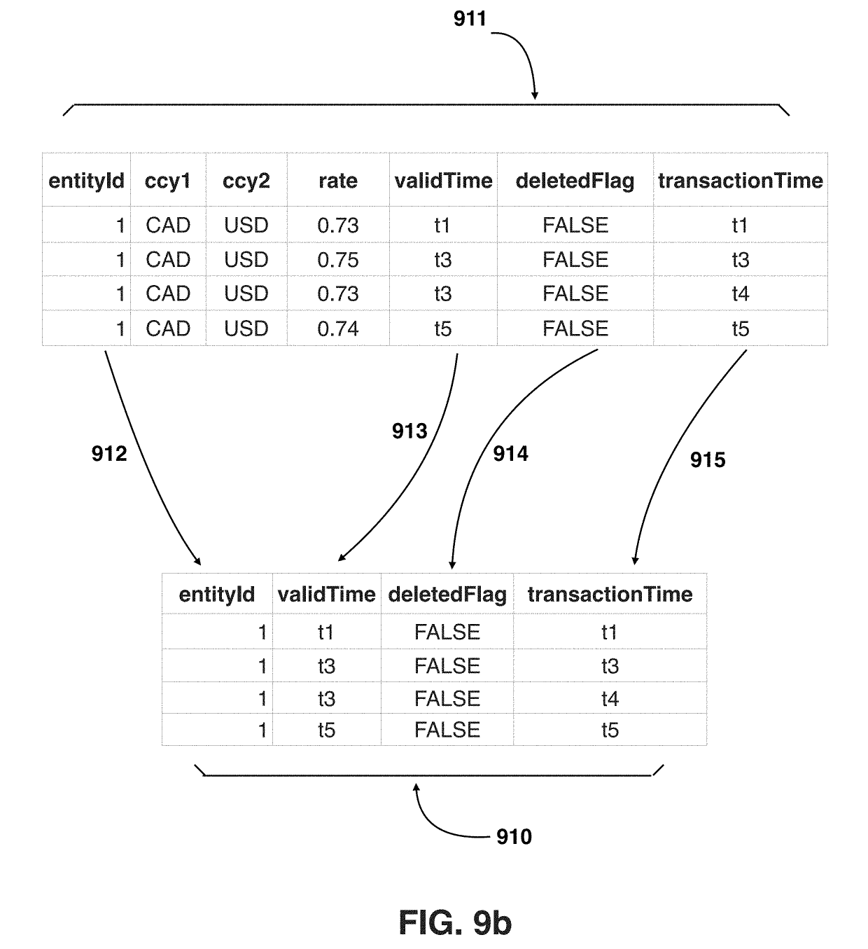

FIG. 9a illustrates an example where versions of the same data record implementing Bi-Temporal, are stored in a table in a database management system, according to an exemplary embodiment of the present invention. As shown, data in a table implements Bi-Temporal data. In addition to the columns described in FIG. 2a, the table has an additional column ‘transactionTime’ 901. Two rows with entityId=1 have validTime=t3 903 and 904, but have different transactionTimes. The Row 903 is operationally valid between t3 and t4, while row 904 is operationally valid between t4 and t5.

Consider a SQL code (4) that retrieve the temporal data based on the temporal criteria

| | | |
|---|---|---|
| SET temporalCriteria=validAsOf:tx,transactionTime:ty; | | |
| SELECT * | {close oversize brace} | (4) |
| FROM CCY_RATE; | | |

The SQL code (4) with a command that sets the temporal criteria to be used. There is no filter condition similar to SQL code (3). The temporal criteria instructs the system to return data that is valid as of time tx and operationally valid as of ty set in the criteria.

FIG. 9b illustrates an example where temporal metadata is extracted from Bi-Temporal data records, according to an exemplary embodiment of the present invention. As shown, the metadata of Bi-Temporal data 910 is stored along with the data records 911. The metadata 912, 913, 914 and 915 is extracted from fields of data records based on configuration (i.e., the name of the fields entityId, validTime, deletedFlag and transactionTime in the data record could be different from the corresponding metadata fields).

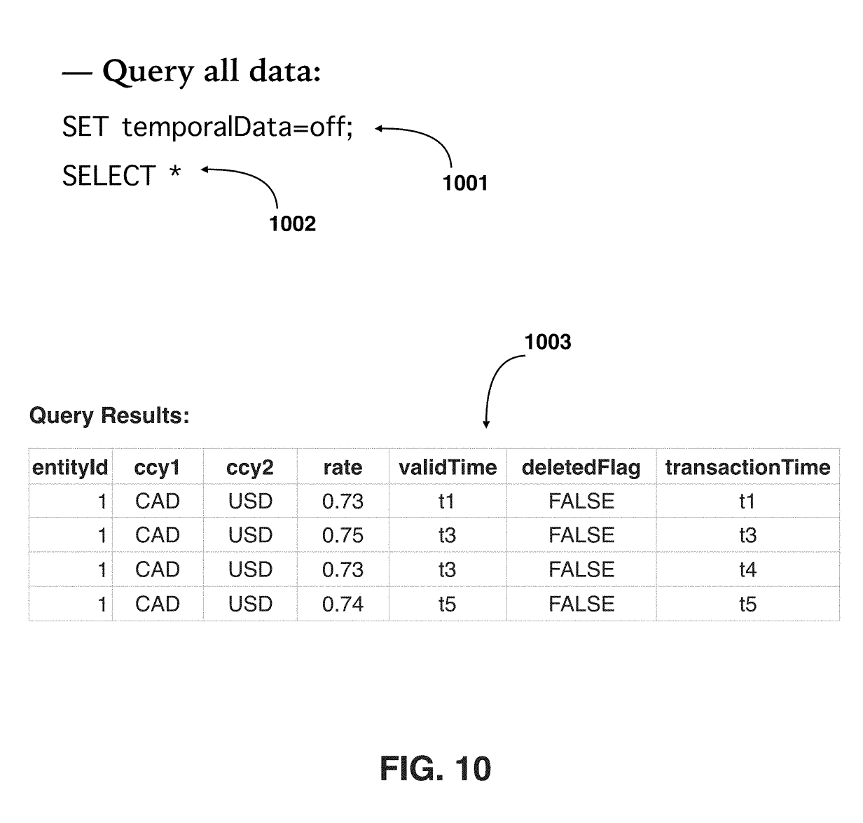

FIG. 10 illustrates an example where all data records are selected when the temporal feature is disabled, according to an exemplary embodiment of the present invention. In absence of temporal criteria provided by the user, a system built according to the present disclosure will assume validTime (and in case of Bi-Temporal data) and transactionTime criteria to be equal to the time of running the query. A user can issue a command similar to 1001 to turn the temporal functionality. A query like 1002 will not filter out any data based on their temporal meta data and will return all versions of data 1003.

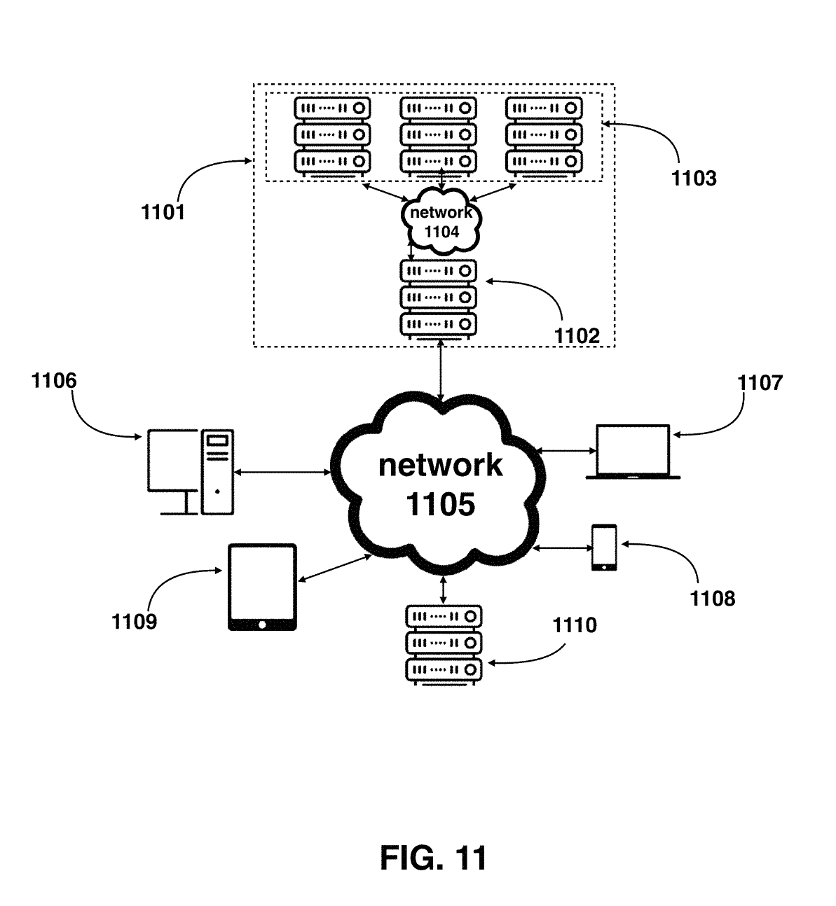

FIG. 11 illustrates a system for implementing a temporal database, according to an exemplary embodiment of the present invention. As shown, plurality of computer systems 1102 receives queries and commands from the user. These computers are connected to other computers 1103 that store data and perform processing through communication network 1105. In an embodiment computer systems 1102 are responsible to analyze the queries and commands manage and instruct computers 1103 to perform processing and return back results. Processing of a single query or command may results in many ‘jobs’ performed by computers 1103. Users and other computer system 1106, 1107, 1108, 1109, and 1110 submit commands and queries through an external network 1105. Computers 1102 return the result of those commands and queries to the submitting party.

Examples of the computer system include, but are not limited to a cell phone, a smart phone, a cellular phone, a cellular mobile phone, a personal digital assistant (PDA), a wireless communication terminal, a laptop, PC, and a tablet computer. Examples of types of the communication network include, but are not limited to a local area network, a wide area network, a radio network, a virtual private network, an internet area network, a metropolitan area network, a satellite network, Wi-Fi, Bluetooth Low energy, a wireless network, and a telecommunication network. Examples of the telecommunication network include, but are not be limited to a global system for mobile communication (GSM) network, a general packet radio service (GPRS) network, third Generation Partnership Project (3GPP), an enhanced data GSM environment (EDGE) and a Universal Mobile Telecommunications System (UMTS).

It will finally be understood that the disclosed embodiments are presently preferred examples of how to make and use the claimed invention, and are intended to be explanatory rather than limiting of the scope of the invention as defined by the claims below. Reasonable variations and modifications of the illustrated examples in the foregoing written specification and drawings are possible without departing from the scope of the invention as defined in the claim below. It should further be understood that to the extent the term “invention” is used in the written specification, it is not to be construed as a limited term as to number of claimed or disclosed inventions or the scope of any such invention, but as a term which has long been conveniently and widely used to describe new and useful improvements in technology The scope of the invention supported by the above disclosure should accordingly be construed within the scope of what it teaches and suggests to those skilled in the art, and within the scope of any claims that the above disclosure supports. The scope of the invention is accordingly defined by the following claims.

What is claimed is:

1. A computer program product for implementing a temporal database, the computer program product including instructions for causing a computer system to implement a method, comprising:
extracting temporal metadata from data records based on configuration;
storing the temporal metadata;
determining temporal criteria set by a user ;
filtering data records based on the temporal criteria and the temporal metadata before passing them to the query engine; and
further processing, filtering and joining with data from other tables or data collections by the query engine.

2. The computer program product of claim 1, wherein the temporal metadata is extracted from the data records when data is added to the database, based on user configuration or system configuration.

3. The computer program product of claim 1, wherein all data records distributed over files locations or memory locations, sorted based on the temporal metadata by entity identifier and relevant time stamps in descending order.

4. The computer program product of claim 1, further read the distributed data chunks in a manner that data records from all chunks are read sorted, based on the temporal metadata, by entity identifier and relevant time stamps in descending order.

5. The computer program product of claim 1, wherein the data records and temporal metadata are distributed over files, memory locations and computers in chunks are time to time compacted to fewer files, memory locations and chunks based on system configuration or by user command.

6. The computer program product of claim 5, wherein the data records and temporal metadata in the resulting files or memory locations are sorted by entity identifier and relevant time stamps in descending order.

7. The computer program product of claim 1, wherein the temporal database is implemented as a relational or non-relational or nosql database.

8. The computer program product of claim 1, wherein data is stored in memory or stored on disk or any other storage medium or a combination of all.

9. The computer program product of claim 1, wherein data is stored in a single computer system or distributed over multiple of computer systems and storage media.

10. The computer program product of claim 1, wherein processing is performed in a single computer system or distributed over plurality of computer system.

11. The computer program product of claim 1, wherein every transaction creates a new data record resulting in one or more data records with the same entity identifier in the database where only one of data records with the same identifier is valid at a point in time.

12. The computer program product of claim 11, wherein every transaction is at least one of logical INSERT, UPDATE and DELETE, and the new data record is append only.

13. The computer program product of claim 1, wherein the temporal metadata includes an entity identifier, wherein the entity identifier identifies the data record at each point in time and is common to all versions of the same data record.

14. The computer program product of claim 1, wherein the temporal metadata includes a valid time, wherein the valid time refer the time when the record start to be valid.

15. The computer program product of claim 1, wherein the temporal metadata includes a transaction time, wherein the transaction time indicates the time when the record was inserted to the system or one of its source systems.

16. The computer program product of claim 1, wherein the temporal metadata includes a deleted flag, wherein the deleted flag indicates whether the record is deemed to be deleted and is not be visible for a valid time criteria on and later than the record's valid time.

17. The computer program product of claim 1, wherein the temporal criteria is specified by the user by issuing a special command before the query is submitted or as a part of the query.

18. The computer program product of claim 1, wherein the temporal criteria is specified by the user by issuing a special command before the query is submitted or as a part of the query for all tables or specific list of tables or collections of data records.

19. The computer program product of claim 1, wherein the temporal criteria includes ‘validTime’ and an optional ‘transactionTime’.

20. The computer program product of claim 1, wherein temporal feature can be enabled or disabled by the user by issuing a special command

21. A method of implementing a temporal database, the method comprising:
receiving one or more transactions that perform one or more operations to a table;
wherein one or more operations comprises at least one of add new records, update existing records, or deleting existing records wherein the table comprises a collection of data records;
storing the data records within chunks, distributed over plurality of computer and storage media, wherein the data records are sorted by one or more parameters;
extracting temporal metadata from data records based on configuration;
storing the temporal metadata;
receiving temporal criteria entered by the user using a special command or part of query; and
filtering data records of each partition, table or data collection based on the temporal criteria and the temporal metadata before further processing, filtering and joining with data from other tables or data collections by the query engine.

22. The method of claim 21, wherein each record comprises an entity identifier (entityId), a valid time, optional a transaction time, and a ‘deletedFlag’, where the entityId is common among all versions of the data record and each data record is uniquely identified by its entityId, valid time and optional transaction time.

23. The method of claim 21, wherein one or more meta data comprises of least one of entityId, valid time and optional transaction time.

24. The method of claim 21, wherein the method further comprising:
receiving a query submitted by the user to be executed as of point in time stated in the temporal criteria;
reading the data records from the storage, in case the data records for the same identifier stored in chunks;
sorting all data records with the same identifier based on their valid time and optional transaction time;
finding a single data record that is valid as of the point in time stated by temporal criteria, if any, among all having the same identifier, and discarding the rest;
passing the valid data records for further processing, filtering and joining with data from other tables or data collections by the query engine; and
compacting chunks of data with the same identifier to reduce the number of chances chunks based on system configuration of user command.

25. A system for implementing a temporal database comprising:
a memory;
a processor, coupled to the memory; wherein the processor is configured to:
receiving one or more transactions that perform one or more operations to a table; wherein one or more operations comprises at least one of add new records, update existing records, or deleting existing records wherein the table comprises a collection of data records;
storing the data records within a chunks and distributed over plurality of computer and storage media, wherein the data records are sorted by one or more parameters;
extracting temporal metadata from data records based on configuration;
storing the temporal metadata;
receiving temporal criteria entered by the user using a special command; and
filtering data records of each partition, table or data collection based on the temporal criteria and the temporal metadata before further processing, filtering and joining with data from other tables or data collections by the query engine.

26. The system of claim 25, wherein each record comprises an entity identifier (entityId), a valid time, optional a transaction time, and a ‘deletedFlag’, where the entityId is common among all versions of the data record and each data record is uniquely identified by its entityId, valid time and optional transaction time.

27. The system of claim 25, wherein the processor is further configured to:
receiving a query submitted by the user to be executed as of point in time stated in the temporal criteria;
reading the data records from the storage, in case the data records for the same identifier stored in chunks;
sorting all data records with the same identifier based on their valid time and optional transaction time;
finding a single data record that is valid as of the point in time stated by temporal criteria, if any, among all having the same identifier, and discarding the rest;
passing the valid data records for further processing, filtering and joining with data from other tables or data collections by the query engine; and
compacting chunks of data with the same identifier to reduce the number of chances based on system configuration of user command.
